(19) United States
(12) Patent Application Publication
(10) Pub. No.: US 2013/0147654 A1
(43) Pub. Date: Jun. 13, 2013

(54) RADAR APPARATUS

(71) Applicant: MANDO CORPORATION, Pyeongtaek-si (KR)

(72) Inventors: Seung Un CHOI, Suwon-si (KR); Seong Hee JEONG, Yongin-si (KR)

(73) Assignee: MANDO CORPORATION, Pyeongtaek-si (KR)

(21) Appl. No.: 13/710,068

(22) Filed: Dec. 10, 2012

(30) Foreign Application Priority Data
Dec. 9, 2011 (KR) 10-2011-0131679

(51) Int. Cl. G01S 13/93

(52) U.S. Cl. CPC G01S 13/931
USPC 342/70

(57) ABSTRACT

The present invention relates to a radar technology, and in more particular, to a radar apparatus having an antenna arrangement capable of removing a non-detected region which may exist around a vehicle.

### CROSS-REFERENCE TO RELATED APPLICATION

This application claims priority from and the benefit under 35 U.S.C. §119(a) of Korean Patent Application No. 10-2011-0131679, filed on Dec. 9, 2011, which is hereby incorporated by reference for all purposes as if fully set forth herein.

### BACKGROUND OF THE INVENTION

1. Field of the Invention

The present invention relates to a radar technology.

2. Description of the Prior Art

Recently, a vehicle is provide with various control systems, for example, an adaptive cruise control system (“ACC”), a Stop & Go system, a blind spot detection system (“BSD”), a rear cross traffic alert system (“RCTA”), a lane change assist system (“LCA”), and a rear pre-crash system (“RPC”).

The control systems as mentioned above detect a neighboring object using a detector technology, such as, a radar to perform a corresponding control on the basis of a detected result.

For example, the ACC and the Stop & Go system detect an object, such as a neighboring vehicle, existing in a front region of a vehicle, to perform a corresponding control, such as a vehicle running control. The BSD, the RCTA, the LCA, and the RPC detect an object, such as a neighboring vehicle, existing in a lateral rear side of a vehicle, to perform a corresponding control function for accident reduction or the like.

As described above, various control systems use a detector, such as a radar apparatus, in order to detect surroundings. For example, a radar apparatus for detecting a front side region of a corresponding vehicle is mounted in the vehicle to be applied to, for example, the ACC and the STOP & GO system, and a radar apparatus for detecting a lateral rear side region of the vehicle to be applied to, for example, the BSD, the RCTA, the LCA, or the RPC.

Even if a radar apparatus mounted on the front side of the vehicle detects a front side region, and a radar apparatus mounted on a lateral rear side of the vehicle detect a lateral rear side, a non-detected region, which may not be detected, may exist around the vehicle.

That is, when a conventional radar apparatus is mounted on a vehicle, a non-detected region exists around the vehicle. The non-detected region is also called a “dead zone”.

Due to the existence of such a non-detected region, there is a danger of causing a fatal accident or a vehicle accident because a pedestrian or a neighboring vehicle existing in a lateral side is not detected. In particular, in a lateral side or lateral rear side of the vehicle, a non-detected region exists which may not be detected by a radar apparatus mounted on a lateral rear side of the vehicle. Because such a non-detected region may be a region which may not be seen by the driver's eye through a rearview mirror, the danger of accident is further increased.

### SUMMARY OF THE INVENTION

Accordingly, the present invention has been made to solve the above-mentioned problems occurring in the prior art, and an object of the present invention is to provide a radar apparatus capable of removing a non-detected region which may exist around a vehicle.

In order to accomplish this object, there is provided a radar apparatus including: an antenna device comprising two or more antennas, and an antenna attachment device formed with a plurality of faces so that the two or more antennas are attached to the antenna attachment device; a signal transmission/reception module configured to transmit signals through the two or more antennas, and to receive signals reflected from a neighboring object; and a signal processing module configured to conduct a signal processing to detect the neighboring object. The plurality of faces may include two or more antenna attachment faces, and normal vectors respective for the two or more antenna attachment faces take different directions. In addition, at least one of the signal transmission/reception module and the signal processing module is configured as a circuit on at least one of the plurality of faces formed on the antenna attachment device.

An angle formed by the normal vectors respective for the two or more antenna attachment faces is determined according to a detection angle of each of the two or more antennas attached to the two or more antenna attachment faces.

The radar apparatus may be mounted on a vehicle at a mounting angle determined according to a detection angle of each of the two or more antennas attached to the two or more antenna attachment faces.

The detection angle of each of the two or more antennas may be a design value determined according to information for a range of the non-detected region.

Each of the two or more antennas may include one or more array antennas.

According to the present invention as described above, it is possible to a radar apparatus having an antenna arrangement capable of removing a non-detected region which may exist around a vehicle.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates non-detected regions to be removed in an exemplary embodiment of the present invention;

FIG. 2 is a block diagram illustrating a radar apparatus according to an exemplary embodiment of the present invention;

FIG. 3 is a block diagram of an antenna device according to an exemplary embodiment of the present invention;

FIG. 4 is a view for determining the possibility of existence of a non-detected region according to an angle formed by antenna attachment faces in a radar apparatus according to an exemplary embodiment of the present invention;

FIG. 5 is an illustrative view for exemplifying an antenna attachment device to which two antennas included in a radar apparatus according to an exemplary embodiment of the present invention are attached;

FIG. 6 is an illustrative view for describing a non-detected region absence condition according to an angle formed by the antenna attachment faces in the radar apparatus according to an exemplary embodiment of the present invention;

FIG. 7 is an illustrative view for describing a non-detected region absence condition according to a mounting angle a of the radar apparatus according to an exemplary embodiment of the present invention; and

FIG. 8 illustrates that the non-detected regions existing in FIG. 1 are removed when the inventive radar apparatuses 200 are mounted on the lateral rear sides of the vehicle.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

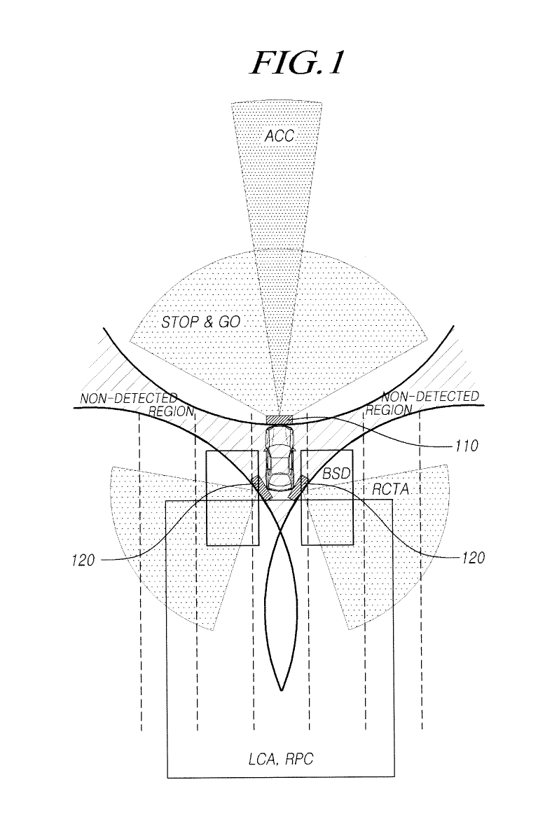

FIG. 1 illustrates non-detected regions to be removed by an exemplary embodiment of the present invention.

Referring to FIG. 1, recently, a vehicle is provided with various control systems, for example, an adaptive cruise control system (“ACC”), a Stop & Go system, a blind spot detection system (“BSD”), a rear cross traffic alert system (“RCTA”), a lane change assist system (“LCA”), and a rear pre-crash system (“RPC”).

The control systems as mentioned above detect a neighboring object using a detector technology, such as, a radar, to perform a corresponding control on the basis of a detected result.

For example, the ACC and the Stop & Go system detect an object, such as a neighboring vehicle, existing in a front side region of a vehicle, to perform a corresponding control, such as a vehicle running control. The BSD, the RCTA, the LCA, and the RPC detect an object, such as a neighboring vehicle, existing in a lateral rear side region of a vehicle, to perform a corresponding control function for accident reduction or the like.

As described above, various control systems use a detector, such as a radar apparatus, in order to detect surroundings.

Referring to FIG. 1, a radar apparatus 110 for detecting a front side region of a corresponding vehicle is mounted on the vehicle to be applied to, for example, an ACC or a STOP & GO system, and radar apparatuses 120 for detecting a lateral rear side region of the vehicle to be applied to, for example, a BSD, an RCTA, an LCA, and an RPC.

Even if the radar apparatus 110 mounted on the front side of the vehicle detects the front region, and the radar apparatuses 120 mounted on the lateral rear sides of the vehicle detect the lateral rear side regions, a non-detected region, which may not be detected by the radar apparatuses 110 and 120, may exist around the vehicle, as illustrated in FIG. 1.

That is, when the conventional radar apparatuses 110 and 120 are mounted on a vehicle, a non-detected region exists around the vehicle and may not be detected using the radar apparatuses 110 and 120.

Due to the existence of such a non-detected region, there is a danger of causing a fatal accident or a vehicle accident because a pedestrian or a neighboring vehicle existing in a lateral side may not be detected. In particular, a non-detected region existing in a lateral side or in a lateral rear side of the vehicle may not be detected by the radar apparatuses 120 mounted at the lateral rear portions of the vehicle. Because such a non-detected region may be a region which may not be seen by the driver's eye through a rearview mirror, the danger of accident is further increased.

Accordingly, an exemplary embodiment of the present invention proposes a radar apparatus with an antenna arrangement for removing a non-detected area as illustrated in FIG. 1.

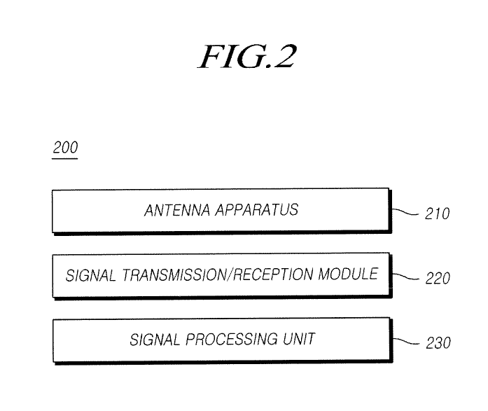

Hereinbelow, a radar apparatus, which enables a non-detected region to be absent, will be described in more detail with reference to FIGS. 2 to 7.

FIG. 2 is a block diagram illustrating a radar apparatus 200 according to an exemplary embodiment of the present invention.

Referring to FIG. 2, the radar apparatus 200 according to an exemplary embodiment of the present invention includes an antenna device 210 including two or more antenna devices, a signal transmission/reception module 220 configured to transmit signals through the two or more antennas and to receive reflected signals when the transmitted signals are reflected by a neighboring object, and a signal processing module 230 configured to conduct a signal processing for detecting the neighboring object.

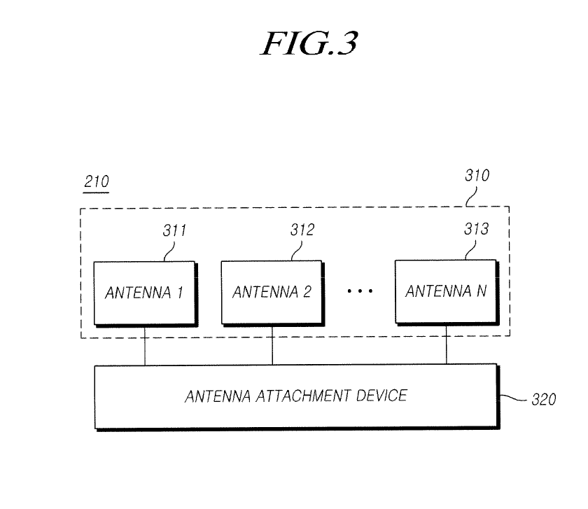

The above-mentioned antenna device 210 will be described in more detail with reference to FIG. 3.

FIG. 3 is a block diagram of the antenna device 210 according to an exemplary embodiment of the present invention.

Referring to FIG. 3, the antenna device 210 according to the present exemplary embodiment may include an antenna module 310 provided with two or more antennas 311, 312, . . . , and an antenna attachment device 320 formed with a plurality of faces to which the two more antennas 311, 312, . . . are attached.

At least one of the signal transmission/reception module 220 and the signal processing module 230 may be configured as a circuit on at least one of the plurality of faces formed on the antenna attachment device 320. As such, it is possible to substantially reduce the size of the radar apparatus 200.

The antenna module 310 illustrated in FIG. 3 includes an antenna 1 311, an antenna 2 312, . . . , and an antenna N 313, in which N may be an integer not less than 2.

The plurality of faces formed on the antenna attachment device 320 included in the antenna device 210 include two or more antenna attachment faces.

For example, in a case where the antenna attachment device 320 is fabricated as a structure of a rectangular parallelepiped shape consisting of six faces, and the antenna module 310 includes two antennas 311 and 312, the two antennas 311 and 312 may be attached to two faces among the six faces of the antenna attachment device 320, respectively.

Normal vectors respective for the two or more antenna attachment faces may take different directions, respectively. That is, the two or more antenna attachment faces may be angled by a predetermined angle in relation to each other.

For example, if the antenna attachment device 320 is fabricated as a structure of a rectangular parallelepiped shape consisting of six faces, the two or more antenna attachments among the six faces are angled by 90 degrees. That is, the normal vectors respective for the two or more antenna attachment faces take different angles, respectively. In other words, an angle formed by the normal vectors for the two or more individual antenna attachment faces is 90 degrees.

With a different expression, the plurality of faces formed on the antenna attachment device 320 included in the antenna device 210 may include two or more antenna attachment faces, in which one of the antenna attachment faces and another antenna attachment face may be angled by a predetermined angle (≠0°).

Meanwhile, each of the two or more antennas 311, 312, . . . included in the antenna module 310 may have an intrinsic detection angle.

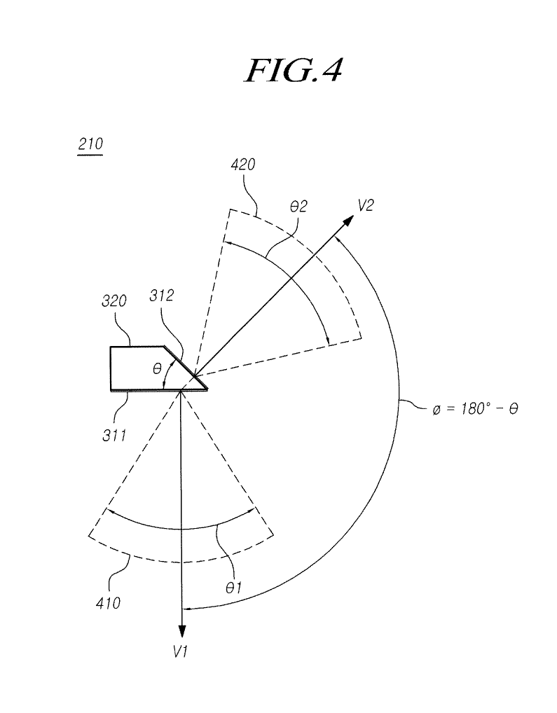

Below, a description will be made with reference to FIG. 4 as to the possibility of existence of a non-detected region according to an angle formed by the two antenna attachment faces, i.e. the possibility of existence of a non-detected region according to an angle formed by the normal vectors respective for the two antenna faces when the two antennas 311 and 312 are attached to the two antenna attachment faces of the antenna attachment device 320, and the detection angle of each of the two antennas 311 and 312 is predetermined as a design value according to the type of a control system that uses the radar apparatus 200.

FIG. 4 is a view for finding out the possibility of existence of a non-detected region according to the angle formed by the antenna attachment faces in the radar apparatus 200 according to the present exemplary embodiment. In FIG. 4, it is assumed that the antenna attachment device 320 has a trapezoid cross-section of which the top and bottom sides are parallel to each other.

As illustrated in FIG. 4, the angle formed by the two antenna attachment faces, to which two antennas 311 and 321 are attached, among the six faces of the antenna attachment device 320 is θ (degrees).

Accordingly, among the two antenna attachment faces, it is assumed that the normal vector of the antenna attachment face, to which the antenna 1 311 is attached, is V1, and the normal vector of the antenna attachment face, to which the antenna 2 312 is attached, is V2.

The angle formed by the normal vector V1 of the attachment face, to which the antenna 1 311 attached, and the normal vector V2 of the attachment face, to which the antenna 2 312 is attached, i.e. the angle φ will be 180-θ(degrees).

The relationship between the angle θ formed by the two antenna attachment faces and the angle φ formed by the normal vectors V1 and 2 of the two antenna attachment faces may be expressed by Equation 1 below.

90°+90°+φ+θ=360° [symbol] φ=180°−θ Equation 1

Meanwhile, among the two antennas 311 and 312, because the detection angle of the antenna 1 311 (maximum detection angle) is designed as θ1, the antenna 1 311 has a first detecting region 410. In addition, among the two antennas 311 and 312, because the detection angle of the antenna 2 312 (maximum detection angle) is designed as θ2, the antenna 2 312 has a second detecting region 420.

Using the relationship between the angle θ formed by the two antenna attachment faces and the angle φ formed by the normal vectors V1 and V2 of the two antenna attachment faces in Equation 1, a condition where a non-detected region is absent between the first detection region 410 of the antenna 1 311 and the second detection region 420 of the antenna 2 312 may be expressed as Equation 2 below

$$\frac{θ 1}{2} + \frac{θ 2}{2} \geq ϕ \qquad Equation 2$$

FIG. 4 is illustrated as a non-detected region exists for the convenience of description. In order to satisfy the non-detected region absence condition of Equation 2, when the detection angles θ1 and θ2 of the two antennas 311 and 312 are predetermined as the designed values, respectively, the angle p formed by the normal vectors V1 and V2 of the two antenna attachment faces should be increased to such an extent that the first detecting region 410 and the second detecting region 420 should be overlapped or come into contact with each other.

Meanwhile, FIG. 4 is illustrated as a non-detected region exists for the convenience of description. In order to satisfy the non-detected region absence condition of Equation 2, when the angle p formed by the normal vectors V1 and V2 of the two antenna attachment faces is predetermined as the designed value, at least one of the detection angles θ1 and θ2 of the two antennas 311 and 312 should be increased to such an extent that the first detecting region 410 and the second detecting region 420 should be overlapped or come into contact with each other.

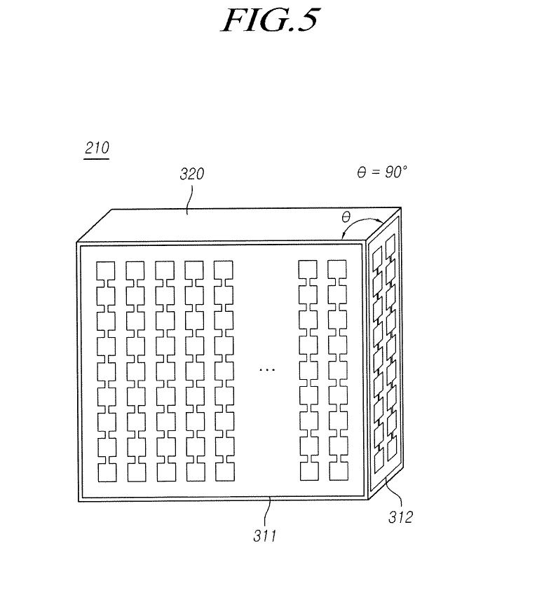

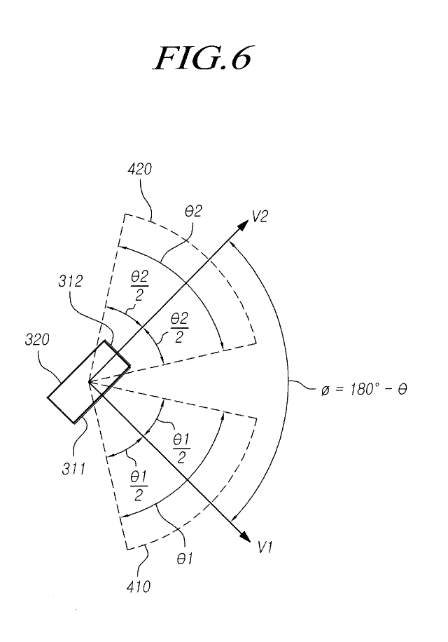

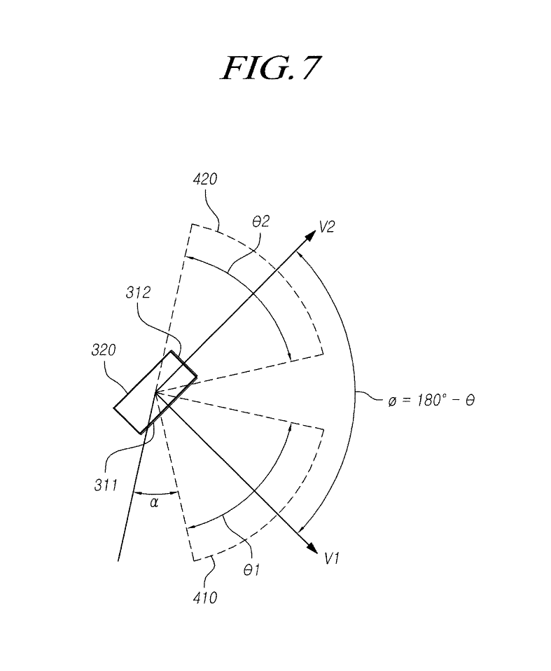

In FIG. 4, the antenna attachment device 320 has a trapezoid cross-section of which the top and bottom sides are parallel to each other. Below, assuming that the antenna attachment device 320 has a rectangular cross-section, which is a specific shape of the trapezoid shape as in FIG. 5, the non-detected region absence is described with reference to FIGS. 6 and 7.

FIG. 5 is an illustrative view for exemplifying an antenna attachment device 320 to which the two antennas 311 and 312 included in the radar apparatus 200 according to the exemplary embodiment of the present invention are attached.

In the antenna attachment device 320 illustrated in FIG. 5, the angle θ formed by the two antenna attachment faces to which the two antennas 311 and 312 are attached is 90°.

Each of the two antennas 311 and 312 attached to the two antenna attachment faces in the antenna attachment device 320 exemplified in FIG. 5 includes a plurality of array antennas.

A description will be made with reference to FIGS. 6 and 7 as to a non-detected region absence condition under the antenna attachment configuration as described above, i.e. under the condition where the angle formed by the two antenna attachment faces to which the two antennas 311 and 312 are attached and the angle formed by the normal vectors of the antenna attachment faces are predetermined.

FIG. 6 is an illustrative view for describing a non-detected region absence condition according to the angle formed by the antenna attachment faces in the radar apparatus 200 according to an exemplary embodiment of the present invention.

The non-detected region absence condition to be described with reference to FIG. 6 is a non-detected region absence condition according to the angle formed by the antenna attachment faces, and will be described as a non-detected region absence condition according to the normal vectors of the antenna attachment faces.

As described above, an angle formed by the normal vectors respective for the two or more attachment faces in the radar apparatus 200 according to an exemplary embodiment of the present invention may be determined according to the detection angles of the two or more antennas attached to the two or more attachment faces in order to ensure that a non-detected region by the two or more antennas attached to the two or more antenna attachment faces is absent.

For example, referring to FIG. 6, in a case where the two or more antenna attachment faces include a first antenna attachment face to which the first antenna 311 is attached, and a second antenna attachment face to which the second antenna 312 is attached, the angle φ formed by the normal vector V1 for the first antenna attachment face and the normal vector V2 for the second antenna attachment face should be not more than a value obtained by dividing the sum of the detection angle θ1 of the first antenna 311 and the detection angle θ2 of the second antenna 312, θ1+θ2, by two so that a non-detected region is absent between the first detecting region 410 of the first antenna 311 and the second detecting region 420 of the second antenna 312. This is expressed as Equation 3.

$$\frac{θ 1}{2} + \frac{θ 2}{2} \geq ϕ \qquad Equation 3$$

Here, because the angle p formed by the normal vector V1 for the first antenna attachment face and the normal vector V2 for the second antenna attachment face and the angle e formed by the two antenna attachment faces have a relationship of φ=180°−θ, and θ is 90°, φ is also 90°. By applying this, Equation 3 may be expressed as Equation 4.

$$\frac{θ 1}{2} + \frac{θ 2}{2} \geq 90 ° \qquad Equation 4$$

In other words, in a case where the antenna attachment device 200 is firstly designed, when the angle θ formed by the antenna attachment faces (=180°− the angle φ formed by the normal vectors of the antenna attachment faces) is firstly determined as a design value, the antenna design should be executed in such a manner that the detection angle θ1 of the first antenna 311 and the detection angle θ2 of the second antenna 312 should satisfy Equation 4.

Here, the antenna design may be executed to determine at least one value among the number of array antennas, the length of the array antennas, and the spacing between the array antennas in each of the first antenna 311 and the second antenna 312.

FIG. 7 is an illustrative view for describing a non-detected region absence condition in the radar apparatus 200 according to an exemplary embodiment of the present invention according to the mounting angle a of the radar apparatus 200.

The non-detected region absence condition to be described with reference to FIG. 7 is a non-detected region absence condition according to the mounting angle a of the radar apparatus 200.

The radar apparatus 200 according to an exemplary embodiment of the present invention may be mounted on a vehicle at a mounting angle determined according to the detection angle of each of the antennas 311, 312, . . . attached to two or more antenna attachment faces in order to ensure that a non-detected region is absent.

Referring to FIG. 7, in a case where the two or more antenna attachment faces include the first antenna attachment face to which the first antenna 311 is attached, and a second antenna attachment face to which the second antenna 312 is attached, the angle p formed by the normal vector V1 of the first antenna attachment face and the normal vector V2 of the second antenna attachment face, and the angle θ formed by the two antenna attachment faces have a relationship of φ=180°−θ.

In addition, assuming that a mounting angle of the radar apparatus 200 is α, the detection angle of the first antenna 311 is θ1, the detection angle of the second antenna 312 is θ2, and the angle of a space between the first detecting region 410 of the first antenna 311 and the second detecting region 420 of the second antenna 312 is X, the sum of all the four angle components is 180°. This relationship may be expressed by Equation 5 below.

α+θ1X+θ2=180° Equation 5

Referring to FIG. 7, in order to ensure that a non-detected region is absent between the first detecting region 410 of the first antenna 311 and the second detecting region 420 of the second antenna 312, X≦0° should be satisfied. Accordingly, the non-detected region absence condition according to the mounting angle α of the radar apparatus 200 may be expressed as Equation 6 below.

X=180°−(α+θ1+θ2)≦0° Equation 6

α≧180°−(θ1+θ2):(A): Equation 6(A)

(θ1+θ2)≧180°−α: Equation 6(B)

If the detection angle θ1 of the first antenna 311 and the detection angle θ2 of the second antenna 312 are values predetermined as design values, referring to Equation 6 (A), the mounting angle a should be larger than that in FIG. 7 so that the angle X of the space between the first detecting region 410 of the first antenna 311 and the second detecting region 420 of the second detecting region 312 X should be not more than 0°, and the radar apparatus 200 should be mounted at the mounting angle α. That is, in the case where the two or more antenna attaching faces include the first antenna attachment face to which the first antenna 311 is attached, and the second antenna attachment face to which the second antenna 312 is attached, the mounting angle α should be not less than an angle obtained by subtracting the sum of the detection angle θ1 of the first antenna 311 and the detection angle θ2 of the second antenna 312 from 180 degrees in order to ensure that a non-detected region should be absent between the detecting region of the first antenna 311 and the detecting region 420 of the second antenna 312.

The detection angle of each of the above-mentioned two or more antennas may be an antenna design value determined according to non-detected region range information.

If the mounting angle a is a value predetermined as a design value, referring to Equation 6(B), the sum of the detection angle θ1 of the first antenna 311 and the detection angle θ2 of the second antenna 312 θ2 should be an angle larger than that in FIG. 7 in order to ensure that the angle x of the space between the first detecting region 410 of the first antenna 311 and the second detecting region 420 of the second antenna 312 should be not more than 0°. Accordingly, the antenna design should be executed such that the detection angle θ1 of the first antenna 311 and the detection angle θ2 of the second antenna 312 should satisfy Equation 6(B).

Here, the antenna design may be executed to determine a value for at least one of the number of array antennas, the length of the array antennas, and the interval of the array antennas in each of the first antenna 311 and the second antenna 312.

Each of two or more antennas 311, 312, . . . described herein may include one or more array antennas.

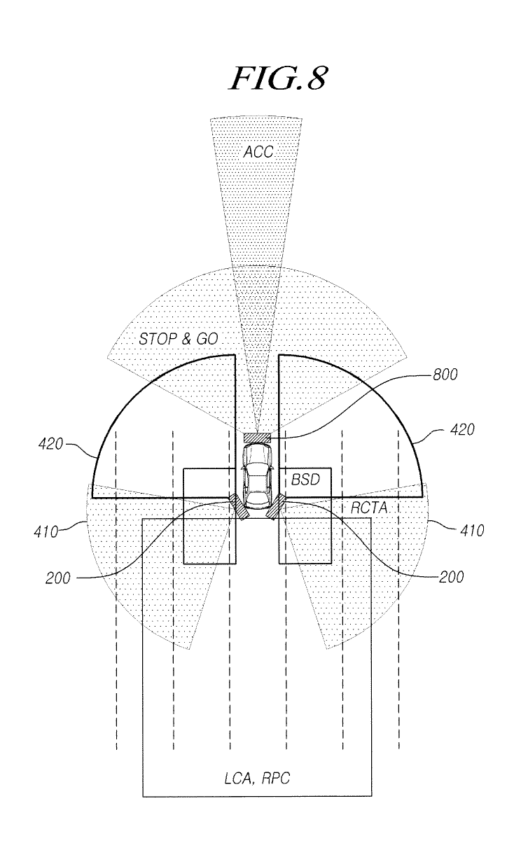

FIG. 8 illustrates that the non-detected regions existing in FIG. 1 are removed when the inventive radar apparatuses 200 are mounted on the lateral rear sides of the vehicle.

When the conventional radar apparatus 110 mounted on the front side of the vehicle detects the front region and the conventional radar apparatuses 120 mounted on the lateral rear sides of the vehicle detect lateral rear regions, non-detected regions, which are not detected, exist in the lateral directions of the vehicle, as illustrated in FIG. 1. However, it will be appreciated that according to the exemplary embodiments of the present invention described above, a plurality of antennas are attached to the different faces of the antenna attachment devices, respectively, thereby producing additional detecting regions 420 to remove the non-detected regions existing in the lateral directions of the vehicle, as illustrated in FIG. 8.

As described above, the inventive antenna device includes two or more antennas, and an antenna attachment device formed with a plurality of faces, so that the plurality of antennas are attached to the antenna attachment device, in which the plurality of faces include two or more antenna attachment faces, and one antenna attachment face and another antenna attachment face form a predetermined angle.

Although several exemplary embodiments have been described above assuming that the inventive radar apparatus 200 is a radar apparatus mounted on a lateral rear side of a vehicle merely for the convenience of description, the inventive radar apparatus 200 may be a radar apparatus mounted on the front side of the vehicle.

As described above, according to the present invention, a radar apparatus and an antenna device can be provided which have an antenna arrangement capable of removing a non-detected region which may exist around a vehicle.

According to prior art, it is necessary to mount an additional radar apparatus in order to remove a non-detected region. According to the present invention, such a non-detected region may be removed with a single radar apparatus 200.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A radar apparatus comprising:
an antenna device comprising two or more antennas, and an antenna attachment device formed with a plurality of faces so that the two or more antennas are attached to the antenna attachment device;
a signal transmission/reception module configured to transmit signals through the two or more antennas, and to receive signals reflected from a neighboring object; and
a signal processing module configured to conduct a signal processing to detect the neighboring object,
wherein the plurality of faces includes two or more antenna attachment faces, and normal vectors respective for the two or more antenna attachment faces take different directions, and
wherein at least one of the signal transmission/reception module and the signal processing module is configured as a circuit on at least one of the plurality of faces formed on the antenna attachment device.

2. The radar apparatus as claimed in claim 1, wherein an angle formed by the normal vectors respective for the two or more antenna attachment faces is determined according to a detection angle of each of the two or more antennas attached to the two or more antenna attachment faces.

3. The radar apparatus as claimed in claim 1, wherein the radar apparatus is mounted on a vehicle at a mounting angle determined according to a detection angle of each of the two or more antennas attached to the two or more antenna attachment faces.

4. The radar apparatus as claimed in claim 2, wherein the detection angle of each of the two or more antennas is a design value determined according to information for a range of the non-detected region.

5. The radar apparatus as claimed in claim 3, wherein the detection angle of each of the two or more antennas is a design value determined according to information for a range of the non-detected region.

6. The radar apparatus as claimed in claim 1, wherein each of the two or more antennas includes one or more array antennas.
